(19) United States
(12) Patent Application Publication
(10) Pub. No.: US 2002/0078173 A1
(43) Pub. Date: Jun. 20, 2002

(54) Data acquisition system and method

(76) Inventors: Paul H. Horn, Huntsville, AL (US); Stephen L. May, Huntsville, AL (US); Gary L. Sutherland, Owens Crossroads, AL (US)

Correspondence Address: LANIER FORD SHAVER & PAYNE, P O BOX 2087, HUNTSVILLE, AL, 35804, US

(21) Appl. No.: 09/962,623

(22) Filed: Sep. 25, 2001

Related U.S. Application Data
(60) Provisional application No. 60/235,092, filed on Sep. 25, 2000.

(51) Int. Cl. G06F 15/16

(52) U.S. Cl. 709/218; 709/250

(57) ABSTRACT

A data acquisition apparatus acquires sensor data indicative of an operational state of an external operational unit and provides the sensor data to a remote host. To achieve this functionality, the data acquisition apparatus utilizes memory, a first data interface, a second data interface, and logic. The first data interface is configured to receive sensor data that is indicative of an operational state of an external operational unit, and the second data interface is configured to communicate with a remote host. The logic is configured to store the sensor data in the memory and, when requested, to communicate the sensor data to the remote host via the first data interface.

### CROSS REFERENCE TO RELATED APPLICATION

This document claims priority to and the benefit of the filing date of copending provisional application entitled “Network Enabled Data Acquisition and Control System and Method,” assigned Serial No. 60/235,092, and filed Sep. 25, 2000, which is incorporated herein by reference.

### BACKGROUND OF THE INVENTION

1. Field of the Invention

The present invention generally relates to data acquisition techniques and, in particular, to a system and method for acquiring data from an operational unit to enable monitoring and/or control of the operational unit.

2. Related Art

Data acquisition devices have been employed in a variety of applications for monitoring and/or controlling various operational units. An “operational unit” can be any functional device known in the art. An example of an operational unit is a vehicle for transporting passengers to various locations. Moreover, a vehicle often includes a data acquisition device, such as a processor, that receives operational information from various sensors, such as, for example, engine temperature sensors, air or fluid flow sensors, speed detection sensors, etc. The data acquisition device may control one or more operational features of its associated vehicle based on the operational information received from one or more sensors. For example, upon detecting an unusually high engine temperature, the processor may manipulate one or more engine settings in an attempt to prevent the engine from overheating.

Many data acquisition devices, in addition to automatically monitoring and controlling an operational unit, have the capability of providing the information being monitored to a technician that can utilize the information for diagnostic purposes. For example, the aforedescribed vehicular data acquisition device may include an interface that allows it to exchange data with a host computer, for example. When the vehicle experiences operational problems, a technician interfaces such a host computer with the data acquisition device, which provides information acquired from the vehicle's sensors to the host computer. The host computer then displays the monitored information to the technician who may analyze the displayed information in order to diagnose the operational problems being experienced by the vehicle.

However, taking a monitored unit, such as the aforedescribed vehicle, to a technician or having the technician come to the monitored unit for diagnostic purposes can be burdensome to either the user of the monitored unit or the technician. Furthermore, some operational problems, particularly sporadic operational problems, may not occur or be detected when the technician's host computer is interfaced with the unit's data acquisition device making it difficult for the technician to correctly diagnose the unit's operational problems.

Furthermore, a data acquisition device may not necessarily be designed to provide any or all of the inputs needed for running the operational unit properly, and a user sometimes must provide control inputs based on the information being monitored by the data acquisition device. For example, a data acquisition device may detect an operational temperature of a particular unit and display information indicative of the detected temperature via an interface (e.g., a display device) of the data acquisition device. A user may then provide manual inputs for establishing a desired operational temperature. The data acquisition device may then control the operation of the unit such that the operating temperature is maintained within the desired range.

Such an operational unit may be an air-conditioner where a user is able to provide manual inputs for changing the temperature of a room being cooled by the air-conditioner. Although the user is able to control the operation of the unit (i.e., the air-conditioner) via the data acquisition device, the user's presence at the data acquisition device is usually required for the user to either obtain operational information about the unit or to submit a control input.

Another drawback with typical data acquisition devices is the high cost usually associated with designing and installing the data acquisition devices. A trained technician or engineer often designs different data acquisition devices for different applications depending on the information being monitored or the sensors being used in the different applications. Tailoring the design of data acquisition devices to different applications, in general, increases the cost of data acquisition devices.

### SUMMARY OF THE INVENTION

The present invention overcomes the inadequacies and deficiencies of the prior art as discussed hereinbefore. Generally, the present invention provides a data acquisition apparatus and method for acquiring sensor data indicative of an operational state of an external operational unit and providing the sensor data to a remote host.

In architecture, the data acquisition apparatus of the present invention utilizes memory, a first data interface, a second data interface, and logic. The first data interface is configured to receive sensor data that is indicative of an operational state of an external operational unit, and the second data interface is configured to communicate with a remote host. The logic is configured to store the sensor data in the memory and, when requested, to communicate the sensor data to the remote host via the first data interface.

Various features and advantages of the present invention will become apparent to one skilled in the art upon examination of the following detailed description, when read in conjunction with the accompanying drawings. It is intended that all such features and advantages be included herein within the scope of the present invention and protected by the claims.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a data acquisition system in accordance with the present invention.

FIG. 2 is a block diagram illustrating a more detailed view of a network depicted in FIG. 1.

FIG. 3 is a block diagram illustrating a more detailed view of a remote host depicted in FIG. 1.

FIG. 4 is a block diagram illustrating a more detailed view of a data acquisition apparatus depicted in FIG. 1.

FIG. 5 is a three-dimensional diagram depicting a housing unit that may be utilized to house the components of the data acquisition apparatus depicted in FIG. 4.

FIG. 6 is a flow chart illustrating the architecture and functionality of the data acquisition apparatus depicted in FIG. 4.

### DETAILED DESCRIPTION OF THE INVENTION

In general, the present invention pertains to a self-contained data acquisition apparatus that acquires operational data from one or more sensors and that provides the acquired data to a remote host over a network, such as a local area network (LAN) and/or wide area network (WAN), for example. In a preferred embodiment, the data acquisition apparatus includes a web server that can interface the acquired data with a remote host over the Internet. Moreover, control inputs may be submitted to the data acquisition device from the remote host. Therefore, a user of the host may remotely monitor and/or control an operational unit connected to the data acquisition device.

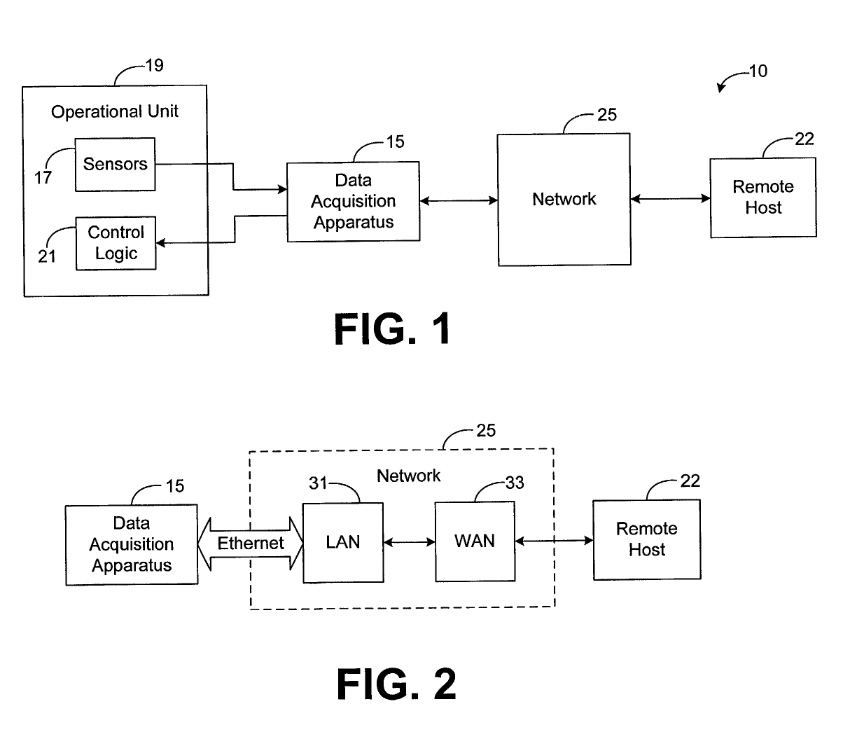

FIG. 1 depicts a data acquisition system 10 in accordance with the present invention. As shown by FIG. 1, the system 10 includes a data acquisition apparatus 15 that is communicatively coupled to one or more sensors 17 of an operational unit 19. The operational unit 19 can be any known mechanical, electrical, and/or chemical device that has or exhibits operational parameters desirable for monitoring and/or controlling. One or more sensors 17 extracts data pertaining to an operational parameter that is to be monitored and provides this data to data acquisition apparatus 15. As an example, the operational unit 19 may comprise a vehicle, and one of the sensors 17 may extract data pertaining to operational information, such as engine temperature and/or engine performance, for example, from the vehicle being monitored. In another example, the operational unit 19 may comprise an air-conditioner, and one of the sensors 17 may extract data pertaining to the air temperature of a room being cooled by the air-conditioner. Other types of devices may be utilized to implement the operational unit 19 in other embodiments, and the sensors 17 may extract similar and/or different operational information from such devices. As shown by FIG. 1, the operational unit 19 may include control logic 21 for controlling the operation of the unit 19. This control logic 21 may be implemented in software, hardware, or a combination thereof.

When desired, the data acquisition apparatus 15 transmits data acquired from the sensors 17 to a remote host 22 via network 25. The network 25 may comprise any known network or combination of networks for communicating data. As an example, the network 25 may comprise a LAN and/or a WAN, such as the Internet, for example. In the preferred embodiment, the data acquisition apparatus 15 wirelessly (e.g., cellular, radio frequency (RF), etc.) communicates with the network 25, although non-wireless communication may occur between the data acquisition apparatus 15 and the network 25 in other embodiments.

FIG. 2 depicts a more detailed view of the network 25 for the preferred embodiment. As shown by FIG. 2, the data acquisition apparatus 15 preferably transmits data to a LAN 31 over a wireless or non-wireless Ethernet link. The LAN 31 then provides the data to a WAN 33, such as the Internet, which routes the data to the remote host 22. Note that the remote host 22 may transmit data to the data acquisition apparatus 15 along the same path in the opposite direction. Also note that other configurations of network 25 are possible without departing from the principles of the present invention.

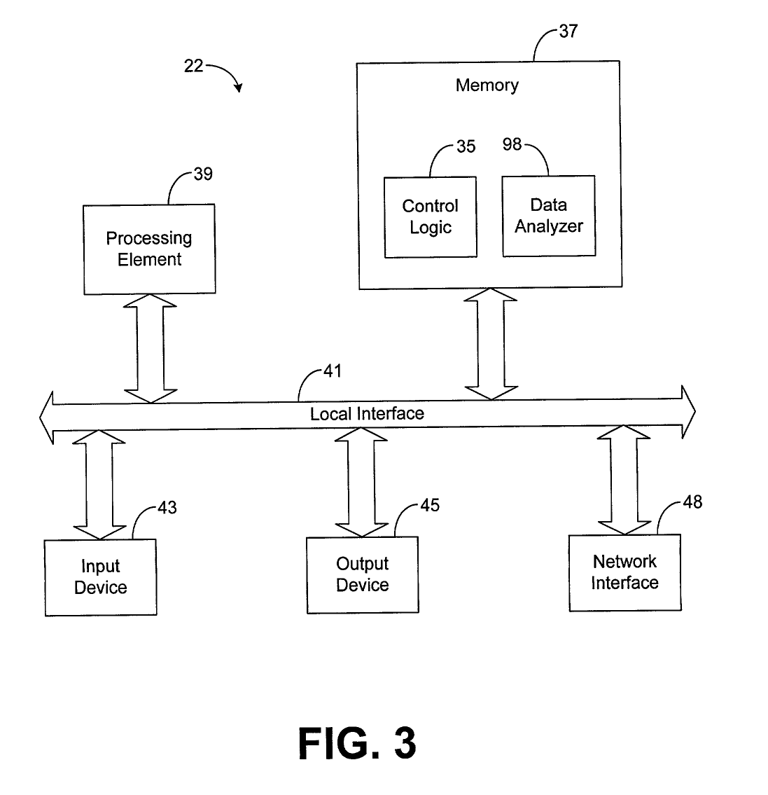

FIG. 3 depicts a more detailed view of the remote host 22. As shown by FIG. 3, the remote host 22 may include control logic 35 that controls the operation and functionality of the remote host 22. The control logic 35 can be implemented in software, hardware, or a combination thereof. In the embodiment shown by FIG. 3, the control logic 35 is implemented in software and stored in memory 37.

The embodiment shown by FIG. 3 also comprises one or more conventional processing elements 39, such as a digital signal processor (DSP) or a central processing unit (CPU), that communicate to and drive the other elements within the host 22 via a local interface 41, which can include one or more buses. Furthermore, an input device 43, for example, a keyboard or a mouse, can be used to input data from a user of the host 22, and an output device 45, for example, a screen display or a printer, can be used to output data to the user. The host 22 also includes a network interface 48 capable of exchanging data with network 25.

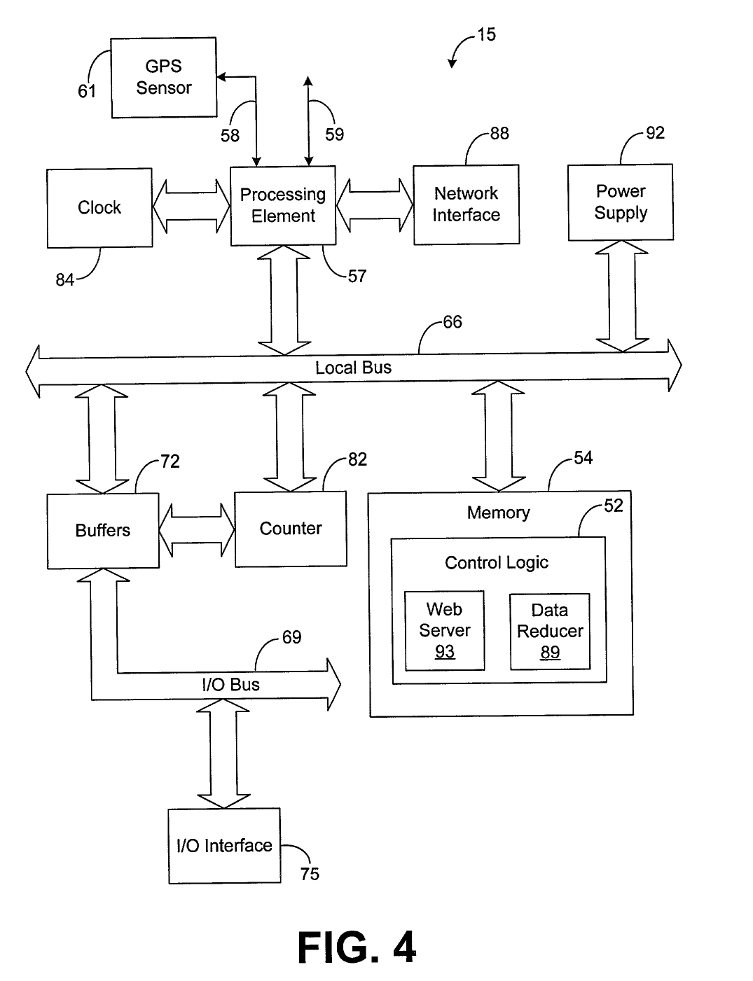

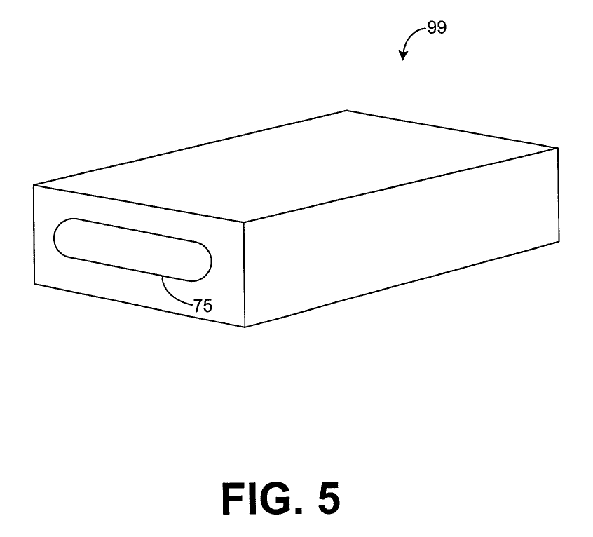

FIG. 4 depicts a more detailed view of the data acquisition apparatus 15. As shown by FIG. 4, the apparatus 15 includes control logic 52 that is configured to control the operation and functionality of the apparatus 15. The control logic 52 can be implemented in software, hardware, or a combination thereof. In the preferred embodiment, as illustrated by way of example in FIG. 4, the control logic 52 of the present invention, along with its associated methodology, is implemented in software and stored in memory 54.

Note that the control logic 52, when implemented in software, can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport a program for use by or in connection with the instruction execution system, apparatus, or device. The computer readable-medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In the preferred embodiment, the control logic 52 is stored in a portion of memory 54 comprising synchronous dynamic random access memory (SDRAM), although the control logic 52 may be stored in other types of memory in other embodiments.

The preferred embodiment of the data acquisition apparatus 15 of FIG. 4 comprises one or more conventional processing elements 57, such as a digital signal processor (DSP) or a central processing unit (CPU), that communicate to and drive the other elements within the apparatus 15. When the control logic 52 is implemented in software, the processing element 57, via conventional processing techniques, processes and executes the instructions of the control logic 52 in order to implement the functionality of the control logic 52, as described herein.

In the preferred embodiment, the processing element 57 comprises one of a family of ARM microprocessors manufactured by NETsilicon™ and more preferably comprises an ARM7 core that is described in U.S. Provisional Patent Application No. 60/235,092. Note that the processing element 57 may be implemented via other types of components in other embodiments.

The ARM7 includes two serial input ports 58 and 59 that may be utilized to receive serial data. In the preferred embodiment, one of these input ports 58 is coupled to a global positioning system (GPS) sensor 61, as shown by FIG. 4. The GPS sensor 61, via conventional techniques, provides location data identifying the current location of the sensor 61 and, therefore, of the apparatus 15. The other serial port 59 of the ARM7 may be coupled to one of the sensors 17 (FIG. 1), if desired.

As shown by FIG. 4, the apparatus 15 preferably includes at least one local bus 66 that enables communication between the processing element 57 and other components, such as memory 54, of the apparatus 15. In the preferred embodiment, the apparatus 15 also includes at least one input/output (I/O) bus 69 separated from the local bus 66 by one or more buffers 72. The I/O bus 69 is coupled to a data interface 75 that is configured to exchange data with the operational unit 19 (FIG. 1) and, more particularly, with the sensors 17 and/or control logic 21 of the operational unit 19. The data interface 75 may include any various types of known communication interface components, such as serial ports for communicating data serially, digital ports for communicating digital data, and/or analog ports for communicating analog signals. The data interface 75 may also include analog-to-digital converters and/or digital-to-analog converters for appropriately processing the data exchanged between the data interface 75 and operational unit 19.

Data to be transmitted from the apparatus 15 to the operational unit 19 is preferably transmitted across the local bus 66 to one or more buffers 72, which then transmit the data across the I/O bus 69 to the data interface 75. The data interface 75 then transmits the data to operational unit 19.

Data transmitted from the operational unit 19 to the apparatus 15 is received by the data interface 75, which transmits the data across the I/O bus 69 to the buffers 72. The buffers 72 then transmit the data across the local bus 66 to other components (e.g., processing element 57 and/or memory 54) of the apparatus 15 for further processing as may be desired.

To enable data to be exchanged between the local bus 66 and the I/O bus 69, each of the buffers 72 is preferably bi-directional, and the direction of each of the buffers 72 is preferably controlled via control signals from a counter 82. In the preferred embodiment, the counter 82 is a dual thirty-two bit presettable up/down counter, although other types of counters may be employed in other embodiments.

Normally, the buffers 72 are configured to transmit across the I/O bus 69. Thus, any data transmitted from the processing element 57 and destined for the data interface 75 should be buffered by the buffers 72 and then transmitted by the buffers 72 across the I/O bus 69 to the data interface 75. Moreover, the counter 82 is configured to determine when the local bus 66 is available and to reverse the transmission direction of the buffers 72 when the counter 82 determines that the local bus 66 is available (i.e., when data is not being otherwise communicated over the local bus 66). Thus, any operational data received by the data interface 75 should be transmitted across the I/O bus 69 to the buffers 72, which then buffers the operational data. Based on control signals from the counter 82, the buffers 72 transmit buffered operational data across the local bus 66 to its appropriate destination (e.g., processing element 57 or memory 54) when the local bus 66 is available.

Separating the local bus 66 from the I/O bus 69 via buffers 72 may be desirable for a variety of reasons. In this regard, the buffers 72 may provide additional electrical drive for communicating data from the data interface 75 to other components (e.g., processing element 57 and/or memory 54) of the apparatus 15. This may be particularly beneficial when the distances between the data interface 75 and the other components are relatively long. The buffers 72 also help to isolate the other components (e.g., processing element 57) from the data interface 75. This may help to prevent the processing element 57 from “crashing” when an unanticipated signal or voltage is received at the data interface 75. However, it should be noted that separating the I/O bus 69 from the local bus 66 is not a necessary feature. Moreover, the buffers 72 and counter 82 may be removed from the apparatus 15, if desired. In such an embodiment, the local bus 66 may communicate data between memory 54, processing element 57, and data interface 75.

To enable remote communication, the apparatus 15 preferably includes a communication interface 88 configured to exchange data with the network 25 (FIG. 1). In the embodiment shown by FIG. 2, the communication interface 88 exchanges wireless signals with a LAN 31. However, other embodiments of the network 25 may be employed to communicate between remote host 22 and apparatus 15. As an example, a cellular network may be utilized to implement network 25, and in such an embodiment, the communication interface 88 may include a cellular modem to enable communication with the network 25. In another embodiment, the network 25 may only comprise a land-based network, such as the PSTN, for example. In such an example, the communication interface 88 preferably includes suitable devices, such as a non-cellular modem, for example, for communicating with the PSTN. It should be apparent to one skilled in the art upon reading this disclosure that various configurations of the network 25 and communication interface 88 may be employed to enable communication of wireless and/or non-wireless signals therebetween.

To provide the components with power, the apparatus preferably includes a power supply unit 92. The power supply unit 92 may include batteries and/or may have an interface for receiving electrical power from an external source. By selecting components having low power requirements, it is possible to minimize the amount of power drawn by the apparatus 15. Average power draws less than approximately three watts (w) have been achieved for the design shown by FIG. 4.

During operation, the sensors 17 generate operational data (i.e., data indicative of the operational state of the unit 19) and transmit this data to the data interface 75. The control logic 52 may be designed to store some or all of this data in memory 54 to enable future analysis of the operational data. Various methodologies may be employed to determine which operational data should be stored in memory 54. For example, each sensor reading received from one or more sensors 17 may be stored in memory 54. Alternatively, readings from one or more sensors 17 may be periodically stored in memory 54 or may be stored in memory 54 at preselected times. In another example, the control logic 52 may be configured to store readings from one or more sensors 17 only in response to certain operational states of the unit 19.

To further illustrate the foregoing example, assume that the operational unit 19 is a vehicle and that a user may only be interested in the operational data when vehicle's engine temperature exceeds a predefined threshold. In such an example, the control logic 52 preferably monitors the operational data indicative of the vehicle's engine temperature and stores operational data from one or more sensors 17 only when the vehicle's engine temperature is determined to be above the predefined threshold. There are various other methodologies that may be employed in order to determine whether and when the control logic 52 should store operational data received from the unit 19.

Furthermore, the control logic 52 may also be designed to automatically transmit, to the remote host 22, some or all of the operational data received from sensors 17. The remote host 22 may then display some or all of the transmitted data to enable a user at the host 22 to remotely monitor the operation of the unit 19. Various methodologies may be employed to determine which operational data should be automatically transmitted to the remote host 22. For example, each sensor reading received from one or more sensors 17 may be transmitted to the remote host 22. Alternatively, readings from one or more of the sensors 17 may be periodically transmitted to remote host 22, or such readings may be transmitted to remote host 22 at preselected times. In another example, the control logic 52 may be configured to transmit readings from one or more sensors 17 and/or a notification message in response to certain events, such as certain operational states of the unit 19.

To further illustrate the foregoing example, assume that the operational unit 19 is a vehicle and that a user may only be interested receiving notification of when the vehicle's engine temperature exceeds a predefined threshold. In such an example, the control logic 52 preferably monitors the operational data indicative of the vehicle's engine temperature. When the vehicle's engine temperature is determined by the control logic 52 to be above the predefined threshold, the control logic 52 transmits a message from the network interface 88, which is routed to remote host 22 via network 25. This message may include operational data and/or may indicate that the vehicle's engine temperature is above the predefined threshold. Note that other events may trigger the control logic 52 to transmit operational data and/or notification messages to remote host 22, and there are various other methodologies that may be employed in order to determine whether and which operational data should be transmitted.

To reduce memory requirements and/or transmission burdens, the control logic 52 preferably comprises a data reducer 89 that is configured to implement a data reduction algorithm in order to reduce the operational data received from the sensors 17. The data reducer 89 may utilize known data reduction algorithms, such as those employed in discriminant analysis, factor analysis, linear regression, etc. Furthermore, the data reducer 89 preferably performs data reduction on the readings received from the sensors 17 before the readings are either stored to memory 54 or transmitted to host 22.

It should be noted that the control logic 52 may be configured to control the operation of the unit 19 based on the operational data received from the sensors 17. More specifically, the control logic 52 may be configured to analyze the operational data and then to transmit one or more control signals to the unit 19 based on the control logic's analysis of the operational data. For example, assume that, as in the aforedescribed examples, the control logic 52 is configured to monitor an engine temperature of the unit 19. In such an example, it may be desirable for the engine to be shut down or otherwise modified when the engine's temperature exceeds a predefined threshold. Once the control logic 52 determines that the engine's temperature exceeds the predefined threshold, the control logic 52 may automatically transmit a control signal to operational unit 19 via data interface 75 causing the engine to shut down or to otherwise behave differently. Note that, in other embodiments, other operational features of the unit 19 may be automatically controlled by the control logic 52 based on the operational data from sensors 17.

Control logic 52 may also be configured to transmit operational data to the host 22 upon request. For example, a user of the host 22, via input device 43, may submit a request to receive operational data. This request may pertain to some or all of the operational data currently being received by the data interface 75, to some or all of the operational data stored in memory 54, or to a combination thereof. The control logic 35 of host 22 transmits, via network interface 48, the request across network 25, which routes the request to apparatus 15 and, more particularly, to network interface 88 of apparatus 15. In response, the control logic 52 of apparatus 15 transmits the operational data requested by the request. For example, assume that the request identifies both the history and the real-time reading of one of the sensors 17. In this example, the control logic 52 retrieves from memory 54 operational data previously received from the one sensor 17 and includes this data in a response message that is returned to host 22. The control logic 52 also preferably includes, in the response message, the real-time reading from the one sensor 17 that is located in buffers 72. In other words, the control logic 52 includes in the response message both the historic readings and the real-time reading from the one sensor 17.

The response message is transmitted, via network 52, from the network interface 88 of apparatus 15 to the network interface 48 of host 22. Upon receiving the message, the control logic 35 of host 22 may be configured to display, via output device 45, the operational data included in the message. Thus, the user of the host 22 is able to remotely monitor the historical and/or the real-time readings of one or more of the sensors 17.

If desired, the user of the remote host 22 may submit a command for controlling an operational feature of unit 19. In response, the control logic 35 of host 22 transmits the command, via network interface 48, to network 25, which routes the command to the network interface 88 of apparatus 15. In response, the control logic 52 of apparatus 15 provides control signals to the unit 19 via data interface 75 to cause the unit 19 to perform the desired functionality.

Note that to facilitate the process of communicating with the apparatus 15, the control logic 52 of apparatus 15 preferably includes a web server 93. The web server 93 is associated with a hypertext transfer protocol (HTTP) address that uniquely identifies the web server 93, and the commands and requests transmitted from the remote host 22 preferably include this address to enable the network 25 to route the commands and messages directly to the apparatus 15. Note that as previously described hereinabove, the network 25 of the preferred embodiment is comprised of an HTTP-compatible LAN 31 (e.g., Ethernet) and an HTTP-compatible WAN 33 (e.g., Internet).

When communication between the remote host 22 and the apparatus 15 is desired by a user at the premises of the host 22, the user may submit an Internet query identifying the HTTP address of the web server 93. The network 25 should route the query to the communication interface 88, which informs the web server 93 of the query. In response, the web server 93 retrieves hypertext markup language (HTML) data defining a web page and transmits this data, via network interface 88, to the network 25, which routes the web page to the host 22. The control logic 35 of the host 22 then displays the web page via output device 45. At this point, the user of the host 22 may submit any future request or commands via the displayed web page. Thus, the communication between the apparatus 15 and remote host 22 may be similar to the communication techniques employed in conventional Internet-based communication systems. Note that any operational data transmitted from the apparatus 15 to the host 22 may be displayed within a web page transmitted by the web server 93.

It should be further noted that utilization of the web server 93 is not a necessary feature, and the web server 93 may be removed from the apparatus 15, if desired. Moreover, it is not necessary for the data communicated between the apparatus 15 and host 22 to conform to HTTP or HTML protocol. Indeed, any suitable protocol for communicating data between the host 22 and apparatus 15 may be employed to implement the system 10.

Note that the control logic 52 preferably allows its configuration to be dynamically changed. For example, a user may dynamically change which operational data or messages are automatically transmitted by the control logic 52. A convenient methodology for achieving the foregoing is by configuring the web server 93 to provide the host 22 with a web page having various user preference options. Upon viewing the web page, the user of host 22 may then select the configuration that is most desirable to him or her. However, other methodologies may be employed to enable a user to modify the operation of apparatus 15. Note that a user of the apparatus 15 may submit changes to the operation of the apparatus 15 via the data interface 75, if desired.

As shown by FIG. 3, the remote host 22 may include a data analyzer 98 for analyzing the operational data transmitted from the apparatus 15 to the host 22. The data analyzer 98 may be implemented in hardware, software, or a combination thereof. In the embodiment shown by FIG. 3, the data analyzer 98 is implemented in software and stored within memory 37 of the host 22.

The data analyzer 98 preferably performs statistical analysis on the operational data in order to provide a better understanding of the operation of unit 19. For example, when similar operational failures or errors occur within the unit 19 over time, the data analyzer 98 may analyze the operational data obtained from the sensors 17 just before each of the failures or errors in order to determine if there are any similarities or patterns. This information may then be utilized to predict future failures or errors based on the operational data provided by the sensors 17. The analysis of historical data in order to predict future operational failures or errors shall be referred to herein as “predictive failure analysis.”

As an example of predictive failure analysis, assume that the difference between two sensors 17 is substantially the same each time a particular type of operational failure occurs within the unit 19. The apparatus 15, according to the techniques described above, may provide the host 22 with the readings of the sensors 17 during the time periods just prior to various failures. The data analyzer 98 may then analyze the readings and discover the aforedescribed similarity. More specifically, the data analyzer 98 may discover that the difference between the readings of the foregoing two sensors 17 is within a particular range referred to hereafter as the “critical range,” just prior to various operational failures. Thus, a user may conclude that when the difference between readings of the foregoing two sensors 17 is within the critical range, an operational failure is about to occur.

The foregoing information may be helpful in diagnosing the cause of the operational failure. Furthermore, the user may reconfigure the control logic 52 such that the control logic 52 analyzes the operational data from the sensors 17 to determine when the difference between readings of the foregoing two sensors 17 is within the critical range. When the control logic 52 detects such an event, the control logic 52 may be configured to then transmit a control signal to the unit 19 in an attempt to prevent the impending operational failure and/or to transmit a notification message to the host 22 in order to notify the user of the impending failure (i.e., to notify the user that the control logic 52 has detected a reading of the foregoing two sensors 17 within the critical range). Upon notification, the user may choose to take further steps in an effort to either document the state of the unit 19 prior to an impending failure or to avoid the impending failure. Note that the foregoing example has been provided for illustrative purposes only, and the data analyzer 98 of the present invention may be configured to perform predictive failure analysis via other techniques, if desired.

It should be further noted that, in the preferred embodiment, the apparatus 15 includes a housing unit 99 (FIG. 5), and each component of the apparatus 15 shown in FIG. 4 is preferably housed by the housing unit 99. The data interface 75 and the network interface 88 are preferably exposed by the housing unit 99 in order to facilitate the process of interfacing the apparatus 15 with the operational unit 19 and network 25. By housing the components of the apparatus 15 within such a housing unit 99, the apparatus 15 may be easily transported and interfaced with existing and/or different operational units 19. Note that the shape of the housing unit 99 shown by FIG. 5 is exemplary, and any convenient shape for the housing unit 99 is possible.

### OPERATION

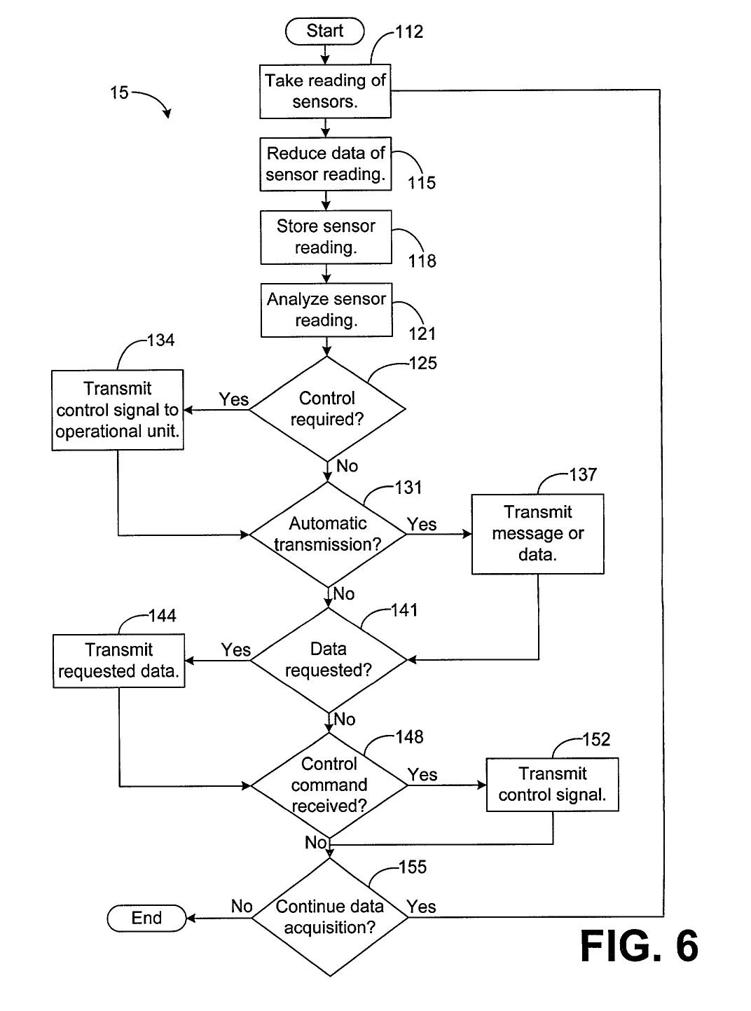

The preferred use and operation of the data acquisition system 10 and associated methodology are described hereafter with particular reference to FIG. 6.

For illustrative purposes, assume that the operational unit 19 comprises a vehicle and that one of the sensors 17 measures the engine temperature of the vehicle. When the engine temperature exceeds a predefined threshold, assume (1) that a user of the host 22 would like to be notified and (2) that the operational unit 19 should be automatically controlled such that the engine power is reduced in an effort to prevent the engine from overheating.

During operation, readings of sensors 17 are taken in block 112. For each reading, the data reducer 89 may perform data reduction in block 115 in order to reduce the amount of data processed by the apparatus 15. In block 118, the control logic 52 stores the data of the reduced readings into memory 54. As shown by block 121, the control logic 52 then analyzes the readings to determine in blocks 125 and 131, respectively, whether or not a control signal should be transmitted to the operational unit 19 or whether a message should be transmitted to the host 22.

For example, assume that the reading taken in block 112 indicates that the engine temperature of unit 19 is above the predefined threshold. In such a case, the control logic 52, in block 125, should determine that the engine power of unit 19 should be reduced. Therefore, the control logic 52 should automatically transmit a control signal in block 134 to cause the unit 19 to reduce engine power. Furthermore, since the engine temperature exceeds the predefined threshold, the control logic 52 should also determine, in block 131, to transmit a message notifying the user of host 22 about the level of the engine temperature. In response, the control logic 52, in block 137, should transmit such a notification message to the host 22 via network interface 88. This message preferably informs the user about the detected event and may include operational data, such as the value of the engine temperature detected in block 112.

It should be noted that the control logic 52 may be configured to automatically provide the remote host 22 with operational data. For example, the control logic 52 may be configured to transmit each reading from one or more sensors 17. In such an example, the control logic 52 transmits such a reading in block 137 regardless of the state of the engine temperature reading.

During the operation of the apparatus 15, a user at the remote host 22 may desire to view certain operational data, either historic or real-time. For example, a user may desire to evaluate the current operation of the unit 19, including the operation of the unit 19 for the last five minutes. In such an example, the user logs on to the Internet, in the preferred embodiment, and submits an HTTP query identifying the HTTP address of the web server 93. This query is routed to the network interface 88 by the network 25, and in response, the control logic 52 returns, to the host 22, web page data that defines a web page. The host 22 then displays a web page based on the foregoing data. Preferably, the web page provides the user with the option of requesting certain operational data. Utilizing the options provided by the web page, the user may submit a request for viewing operational data from one or more sensors 17. The request may indicate that both real-time and historic (for the last five minutes) data is desired.

In response to the request, the control logic 52 transmits the requested data to the host 22, as shown by blocks 141 and 144. The host 22 then displays this data to the user. Upon viewing the displayed operational data, the user may decide that operation of the unit 19 would be improved if the unit's operation were modified. Thus, the user may submit a command for causing the unit 19 to behave in a certain way. The web page previously displayed to the user may provide the user with the option of submitting such a command. This command is then transmitted to the apparatus 15, and response to the transmitted command, the control logic 52 transmits one or more control signals to the unit 19 in order to cause the unit 19 to operate in the commanded manner, as shown by blocks 148 and 152.

As shown by block 155, the aforedescribed process may be repeated as often as desired. In this regard, the monitoring of the operational data from the unit 19 may be terminated upon the occurrence of a particular event, such as the shutting down of operation of the unit 19, for example.

By implementing the data acquisition methodology described above, operational data pertaining to the operation of the unit 19 can be efficiently acquired and monitored at the apparatus 15 and/or at the remote host 22. Furthermore, the data acquisition methodology and/or the operation of the unit 19 can be dynamically controlled via a user either at the premises of the apparatus 15 or at a remote location. In addition, the self-contained unit can be easily coupled to a different type of operational unit 19 and utilized to monitor and/or control the operation of the different unit 19. In this regard, the apparatus 15 can be generically interfaced with many different types of units 19 without modifying the configuration of the apparatus 15 except for, perhaps, the configuration of the control logic 52.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A self-contained data acquisition apparatus, comprising:
memory;
a data interface configured to receive sensor data that is indicative of an operational state of an external operational unit;
a network interface configured to communicate with an external network; and
logic configured to analyze said sensor data and to transmit a control signal to said operational unit for automatically controlling operation of said operational unit based on said sensor data, said logic comprising a web server configured to store said sensor data into said memory and, when requested, to communicate said sensor data, via said network interface, over said network to a remote host via hypertext transfer protocol (HTTP).

2. The apparatus of claim 1, wherein said web server is uniquely associated with an HTTP address and is configured to provide, in response to a request from said remote host identifying said HTTP address, said remote host with data defining a web page, wherein said web page enables said remote host to communicate a request for said sensor data to said web server.

3. The apparatus of claim 1, wherein said control logic comprises a data reducer configured to apply a data reduction algorithm to said sensor data.

4. The apparatus of claim 1, wherein said network interface is configured to establish an Ethernet link with said network.

5. The apparatus of claim 1, further comprising a housing unit, wherein said memory, said data interface, said network interface, and said control logic are housed by said housing unit.

6. The apparatus of claim 1, wherein said network interface is configured to receive a command transmitted from said remote host and received by said network interface, said control logic configured to transmit another control signal via said data interface to said operational unit in response to said command.

7. The apparatus of claim 1, wherein said remote host comprises a data analyzer configured to perform predictive failure analysis based on said sensor data communicated by said control logic.

8. The apparatus of claim 1, wherein said logic is configured to analyze said sensor data and to selectively communicate, based on analysis of said sensor data by said logic, a portion of said sensor data to said remote host.

9. A data acquisition apparatus, comprising:
memory;
a first data interface configured to receive sensor data that is indicative of an operational state of an external operational unit;
a second data interface configured to communicate with a remote host; and
logic configured to store said sensor data in said memory and, when requested, to communicate said sensor data to said remote host via said first data interface.

10. The apparatus of claim 9, further comprising a housing unit, wherein said memory, said first data interface, said second data interface, and said logic are housed by said housing unit, and wherein said logic comprises a web server having a unique hypertext transfer protocol (HTTP) address, said logic configured to communicate said sensor data to said first data interface via HTTP.

11. A method, comprising the steps of:
providing a self-contained data acquisition apparatus having a data interface and a network interface;
communicating sensor data to said data interface, said sensor data indicative of an operational state of an operational unit that is external to said self-contained data acquisition apparatus;
storing said sensor data within said self-contained data acquisition apparatus;
automatically analyzing said sensor data;
automatically transmitting a control signal from said self-contained data acquisition apparatus based on said analyzing step;
automatically controlling operation of said operational unit based on said control signal transmitted from said self-contained data acquisition apparatus; and
communicating said sensor data from said network interface over a network to a remote host.

12. The method of claim 11, further comprising the step of applying a data reduction algorithm to said sensor data via logic residing within said self-contained data acquisition apparatus.

13. The method of claim 11, further comprising the step of performing predictive failure analysis based on said sensor data communicated to said remote host.

14. The method of claim 11, further comprising the step of:
automatically selecting at least a portion of said sensor data based on said analyzing step,
wherein said communicating step includes the step of automatically transmitting said sensor data portion in response to said selecting step.

15. The method of claim 11, further comprising the steps of:
communicating a command from said remote host to said network interface over said network;
transmitting another control signal from said self-contained data acquisition apparatus in response to said command; and
controlling said operation of said operational unit based on said other control signal transmitted from said self-contained data acquisition apparatus.

16. The method of claim 11, wherein said communicating said sensor data step includes the step of transmitting said sensor data via hypertext transfer protocol (HTTP).

17. The method of claim 16, further comprising the step of:
establishing an Ethernet link between said network interface and said network,
wherein said communicating said sensor data step includes the step of transmitting said sensor data via said Ethernet link.

18. The method of claim 16, further comprising the steps of:
storing data defining a web page within said self-contained data acquisition device;
transmitting said web page from said network interface to said remote host;
displaying said web page at said remote host; and
enabling a request for sensor data to be submitted via said web page,
wherein said communicating said sensor data step is performed in response to said request for sensor data.
